(19) United States
(12) Patent Application Publication
(10) Pub. No.: US 2010/0161808 A1
(43) Pub. Date: Jun. 24, 2010

(54) IMAGE FORMING APPARATUS AND SERVICE PROVIDING METHOD

(75) Inventor: Jung-hyuk KWON, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/537,415

(22) Filed: Aug. 7, 2009

(30) Foreign Application Priority Data
Dec. 22, 2008 (KR) 10-2008-0131418

(51) Int. Cl. G06F 15/16

(52) U.S. Cl. 709/227

(57) ABSTRACT

An image forming apparatus, comprising a communication interface unit to communicate with outside, a plurality of web-based applications to use web page information received via the communication interface unit, and a control unit to provide service on an open platform having a web server which shares session information of each of the plurality of web-based applications. Accordingly, session information can be shared between web-based applications.

### CROSS-REFERENCE TO RELATED APPLICATION

This application claims the benefit of Korean Application No. 10-2008-0131418, filed in the Korean Intellectual Property Office on Dec. 22, 2008, the disclosure of which is incorporated herein by reference.

### BACKGROUND OF THE INVENTION

1. Field of the Invention

Aspects of the present invention relate to an image forming apparatus and a service providing method, and more particularly, to an image forming apparatus and a service providing method in which session information of one web-based application can be used in other web-based applications.

2. Description of the Related Art

As digital technology develops and Internet technologies are widely distributed, a digital home has been established in order to provide a user with useful services for his or her everyday life. Digital home technology aims at providing various services utilizing excellent external communication infrastructure, far beyond the concept of simple home networking that shares high-speed Internet, files and other peripheral apparatuses.

An example of such digital home technology is an Open Service Gateway initiative (OSGi) service platform which operates based on a JAVA virtual machine. OSGi provides basic services like HTTP, service management, and log service on a framework. Service providers may provide their services by distributing their services to the OSGi framework in the form of a bundle. Since OSGi supports conventional home network technologies such as UPnp, Jini, and HAVi, it can be used in various environments, such as a TV set-top box, cable modem, alarm system, and energy management system.

Various web-based applications are established on the OSGi framework, and thus various services are provided. Such web-based applications use information, such as a user identification (ID), password, and IP address, as session information, but it is difficult to utilize session information that is used in one web-based application in other web-based applications. In order to share the session information, each web-based application should use a certain library or make adjustment to their application source.

### SUMMARY OF THE INVENTION

Aspects of the present invention relate to an image forming apparatus enabling session information on an open platform to be shared among web-based applications, and a method for sharing web application session information thereof.

According to an aspect of the present invention, an image forming apparatus is provided. The image forming apparatus comprises a communication interface unit to communicate with an external device and a control unit to provide service on an open platform having a plurality of web-based applications which use web page information received via the communication interface unit and a web server which shares session information of each of the plurality of web-based applications.

According to another aspect of the present invention, the session sharing unit may control the web server so that session information of at least one web-based application among the plurality of web-based applications can be provided to other web-based applications of the plurality of web-based applications.

According to another aspect of the present invention, the session sharing unit may control the web server so that if a request for session information is received from at least one of the plurality of web-based applications, the web server determines whether a session name corresponding to the received request for session information exists, and provides the session information corresponding to the session name if the session name exists.

According to another aspect of the present invention, the session sharing unit may control the web server so that if no session name corresponding to the received session information exists, the web server generates default session information and provides the generated default session information.

According to another aspect of the present invention, the session sharing unit divides the plurality of web-based applications into at least two groups, and controls the web server so that session information can be shared only among the web-based applications in the same group.

According to another aspect of the present invention, the session sharing unit may be formed on the open platform in the form of an add-on bundle.

According to another aspect of the present invention, the session information may include user account information, password information, and/or IP address information.

According to another aspect of the present invention, the web-based application may be a copy application, a print application, a fax application, and/or scan application.

According to another aspect of the present invention, an image forming apparatus is provided. The image forming apparatus comprises a control unit to provide service on an open platform including a plurality of web-based application, in which the open platform includes a web server to provide web page information to each of the plurality of web-based application, and a session sharing unit to control the web server to share session information of each of the plurality of the web-based applications.

According to another aspect of the present invention, a service providing method of an image forming apparatus is provided. The method comprises receiving web page information and providing service on an open platform having a plurality of web-based applications based on the received web page information and a web server which shares session information of each of the plurality of web-based applications.

According to another aspect of the present invention, the method further comprises controlling the web server via a session sharing unit of the open platform so that session information of at least one web-based application among the plurality of web-based applications is provided to other web-based applications.

According to another aspect of the present invention, when a request for session information is received from at least one web-based application from the plurality of web-based applications, the method further comprises controlling the web server via the session sharing unit to determine whether a session name corresponding to the received request for session information exists, and providing the session information corresponding to the session name.

According to another aspect of the present invention, the method further comprises controlling the web server via the session sharing unit to generate default session information and provide the generated default session information when no session name corresponding to the received session information exists.

According to another aspect of the present invention, the method further comprises controlling the web server via the session sharing unit to divide the plurality of web-based applications into at least two groups such that session information can be shared only among web-based applications within each group.

According to another aspect of the present invention, the session sharing unit may be formed on the open platform in the form of an add-on bundle.

According to another aspect of the present invention, the providing of the service may comprise receiving a request for session information form at least one web-based application among the plurality of web-based applications; providing the session information to the web-based application which requested the session information when session information corresponding to the received request for session information exists, and opening a session according to the provided session information by the web server and web-based application which requested the session information.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an image forming apparatus according to an embodiment of the present invention;

FIG. 2 and FIG. 3 are block diagrams of an open platform according to an embodiment of the present invention;

FIG. 4 and FIG. 5 illustrate a manifest file structure of a session sharing unit according to an embodiment of the present invention;

FIG. 6 illustrates an activator file structure of the session sharing unit according to an embodiment of the present invention;

FIG. 7 is a flowchart to explain a service providing method according to an embodiment of the present invention;

FIG. 8 is a flowchart to explain the service providing process in FIG. 7 in greater detail; and

FIG. 9 is a flowchart to explain the process of providing session information in FIG. 8 in greater detail.

### DETAILED DESCRIPTION OF THE EMBODIMENTS

Reference will now be made in detail to the embodiments of the present invention, examples of which are illustrated in the accompanying drawings, wherein like reference numerals refer to like elements throughout. The embodiments are described below, in order to explain aspects of the present invention by referring to the figures.

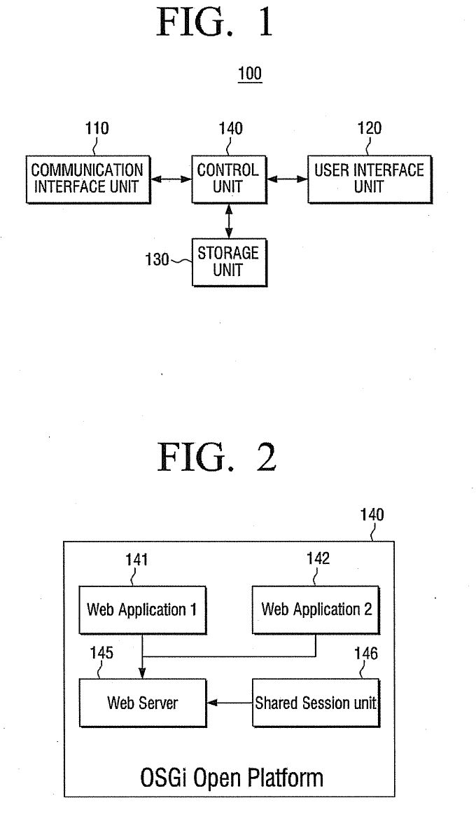

FIG. 1 is a block diagram of an image forming apparatus according to an embodiment of the present invention. The image forming apparatus 100 comprises a communication interface unit 110, a user interface unit 120, a storage unit 130, and a control unit 140. According to other aspects of the present invention, the image forming apparatus 100 may include additional and/or different units. Similarly, the functionality of two or more of the above units may be integrated into a single device.

The communication interface unit 110 is formed to connect the image forming apparatus 100 to an external apparatus. The image forming apparatus 100 may be connected not only via a Local Area Network (LAN) but also via a Universal serial Bus (USB) port or other type of wired or wireless port. The communication interface unit 110 may be connected to a terminal apparatus (not shown) or a server (not shown), and may access a web page corresponding to a web-based application.

If a web page corresponding to a web-based application is present in an external apparatus, the communication interface unit 110 may access the web page corresponding to the web-based application and receive web page information. A web-based application is a program that provides services operable on an open platform such as the OSGi open platform. For instance, if an OSGi-based apparatus is an image forming apparatus, the services may include whatever services the image forming apparatus provides, such as copy, print, scan, and fax services. In the case of the image forming apparatus 100, the web-based applications can be a copy application, print application, scan application, and fax application, which help provide each service. The web-service application is similar to a bundle on the OSGi open platform.

The user interface unit 120 has a plurality of function keys which enable a user to set or select various functions for the image forming apparatus 100, and may display various information provided by the image forming apparatus 100. The user interface unit 120 may be an apparatus capable of inputting and outputting data simultaneously such as a touch pad, or may be an apparatus which combines a mouse with a monitor. A user may input session information into the image forming apparatus 100 using information displayed in the user interface unit 120, and may receive various services provided by a web-based application.

The storage unit 130 may store various web-based applications in the image forming apparatus 100. The storage unit 130 may temporarily store a web page that has been accessed by the communication interface unit 110, and may also store session information used in each process and a session ID corresponding to the session information. The storage unit 130 can be configured as a storage medium mounted inside the image forming apparatus 100, or an external storage medium, such as a removable disk including a USB memory, a storage medium connected to a host, or a web server via a network.

The control unit 140 is operated on an open platform, and may provide service corresponding to a web-based application established on an open platform. The control unit 140 may provide service on an open platform equipped with a plurality of web-based applications which use web page information received via the communication interface unit 110 and a web server which shares session information of each of the plurality of web-based applications.

The open platform is a service platform providing services which can be provided by a web-based application. Although operation and configuration in an OSGi service platform is explained herein, this is only an example; aspects of the present invention are not limited to the OSGi service platform.

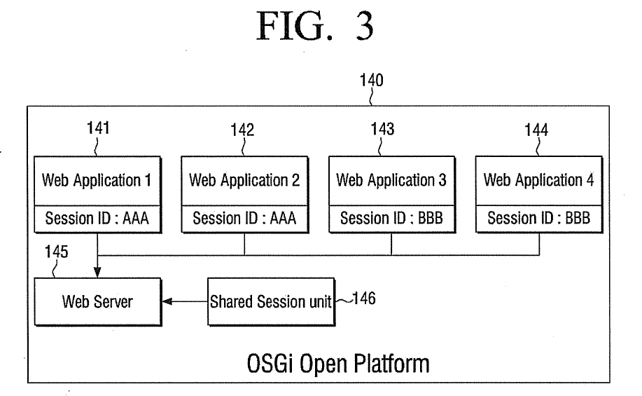

The operation and configuration of the control unit 140 will be explained in detail with reference to FIG. 2 and FIG. 3. FIG. 2 and FIG. 3 illustrate an open platform according to an embodiment of the present invention. Referring to FIG. 2, the open platform according to an embodiment of the present invention may comprise a plurality of web-based applications 141 and 142, a web server 145, and a session sharing unit 146.

The plurality of web-based applications 141 and 142 are formed on the open platform, and may provide various services to a user. The plurality of web-based applications 141 and 142 are formed on an OSGi framework in the form of a bundle, and may provide various services using web page information received via the communication interface unit 110 and web page information stored by the storage unit 130. Examples of web-based applications include copy applications, print applications, scan applications, and fax applications.

The web server 145 may provide the plurality of web-based applications 141 and 142 with web page information. More specifically, the web server 145 may provide web page information received by the communication interface unit 110 or the storage unit 130 to the plurality of web-based applications 141 and 142 which requests the web page information. The web server 145 may be a Apache web server, Jetty web server, or other type of web server supporting web-based applications.

The session sharing unit 146 controls the web server 145 so that session information of at least one web-based application among a plurality of web-based applications can be provided to other applications. If the session sharing unit 146 receives a request for session information from at least one web-based application among a plurality of applications, the session sharing unit 146 determines whether a session name corresponding to the session information request exists, and controls the web server 145 in order to provide the session information corresponding to the session name to the relevant web-based application. If no session name corresponding to the received session information exists, the session sharing unit 146 may control the web server 145 to generate a default session information and to provide the generated default session information to the web-based application that requested the session information.

The session refers to a logical connection between web-based application and web page. The session information refers to information which is used when web-based application opens a session to provide service, and may include, for example, a user account, password, and/or IP address.

In order to provide service corresponding to a web-based application, a session should be opened between the relevant web-based application and corresponding web page. If a plurality of web applications are formed in the image forming apparatus 100, there should be sessions connecting each of the plurality of web-based applications to each of the corresponding web page. The session information is used when such sessions are opened between web-based applications and web pages. However, such session information need not be subject to a single web-based application, and thus session information used in one web-based application can be used in other web-based applications. Accordingly, such session information can be shared by a plurality of web-based applications.

If the session sharing unit 146 receives a request for session information from a web server application, the session sharing unit 146 controls the web server 145 to transmit previously generated session information to the web server application. If no previously generated session information exists, the session sharing unit 146 generates default session information and transmits the default information to the web server application.

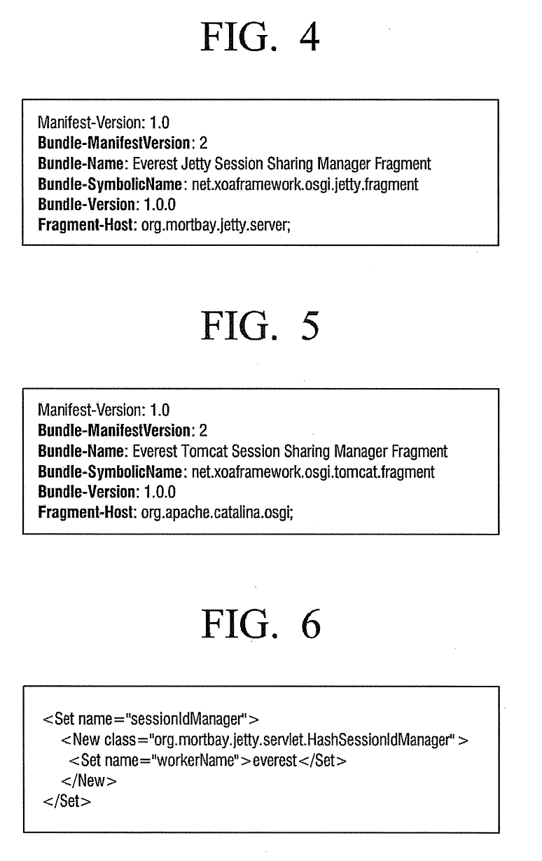

The session sharing unit 146 may be formed on an OSGi framework in the form of an add-on bundle. Various services may be formed on an OSGi framework in the form of a bundle. Such a bundle may be distributed in a contracted format in which a manifest file including information about the bundle and an activator file including an actual service code are contracted in a JAR format. Since a JAR file having the manifest file which informs session sharing operation and the activator file which includes actual service code corresponding to the session sharing operation is formed on the OSGi framework, session information can be shared. The structure of the manifest file and the activator file which performs session sharing operation in the bundle will be explained with reference to FIG. 4 to FIG. 6.

The session sharing unit 146 divides a plurality of web-based applications into groups, and controls the web server 145 so that session information can be shared only among web-based applications in each group. The operation of session sharing unit 146 will be explained with reference to FIG. 3. FIG. 3 is a block diagram of an open platform according to an embodiment of the present invention. Referring to FIG. 3, 4 web-based applications 141, 142, 143, and 144 are formed on the OSGi framework.

If session information is shared between web applications whose session characteristics are different, there may be a clash between web applications. Accordingly, as illustrated in FIG. 3, the session sharing unit 146 divides web-based applications into groups whose session information can be shared with each other, and may control the web server 145 so that session information is shared only within groups.

As illustrated in FIG. 3, web-based applications 141 and 142, which use the same session information, forms a group, and share a single session information having a session ID of ‘AAA.’ Web-based applications 143 and 144, which use the same session information, forms another group, and share single session information having a session ID of ‘BBB.’ Accordingly, if the web-based application 141 performs a session operation and generates session information having a session ID of ‘AAA’, the web-based application 142 can use the session information corresponding to the session ID of ‘AAA’ when performing session operations.

As illustrated in FIG. 3, 4 web-based applications are divided into 2 groups, but 4 web-based applications may be divided into 3 groups, or more than 5 web-based applications may be divided into more than 3 groups.

As such, in the image forming apparatus 100, session information of a web server application can be used in other web server applications. Also, in the image forming apparatus 100, session information can be easily shared simply by forming a separate add-on bundle on the OSGi framework without adjusting the web server application.

According to the description above with regard to FIG. 1 to FIG. 3, the session sharing unit 146 controls the web server 145 so that the session sharing unit 146 can share session information, but the session sharing unit 146 may be combined with the web server 145 so that the server 145 can share session information without forming the session sharing unit 146 separately.

FIG. 4 and FIG. 5 illustrate manifest file structures of a session sharing unit according to an embodiment of the present invention. The manifest file includes basic information about a bundle, and is used to manage the bundle on the OSGi framework.

FIG. 4 illustrates an example of the manifest file structure of the session sharing unit formed on the OSGi framework when a web server is a Jetty web server. The bundle for sharing session information among web-based applications has the name of ‘Everest jetty Session Sharing Manager Fragment’, and is operated in the host of ‘org.mortbay.jetty.server.’

FIG. 5 illustrates an example of the manifest file structure of the session sharing unit formed on the OSGi framework when a web server is a Tomcat web server. The bundle for sharing session information among web-based applications has the name of ‘Everest Tomcat Session Sharing Manager Fragment’, and is operated in the host of ‘org.apache.catalina.osgi.’

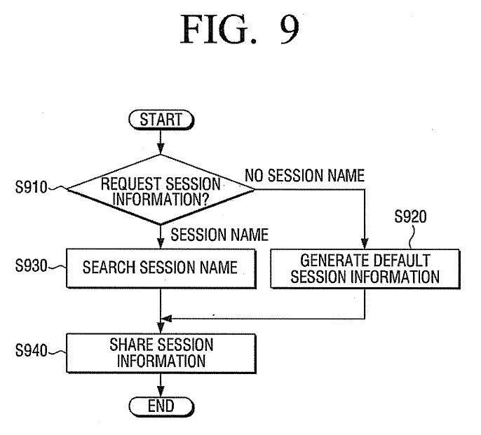

FIG. 6 illustrates an activator file structure of the session sharing unit according to an embodiment of the present invention. FIG. 6 illustrates an example of an activator file structure formed on the OSGi framework when a web server is a Jetty web server. The activator file registers an actual code of the relevant bundle, that is, registers service to the OSGi framework. The activator file of the present invention may have code to perform a logical operation, as illustrated in FIG. 9.

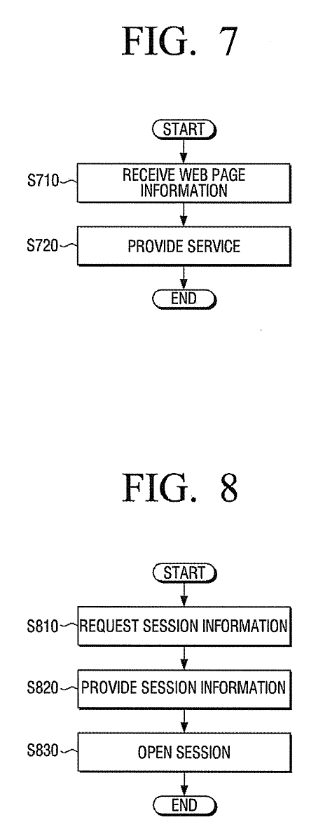

FIG. 7 is a flowchart of a service providing method according to an embodiment of the present invention. First, web page information is received in operation S710. If a service corresponding to the web-based application formed on the OSGi framework is performed, web page information for contacting a web page corresponding to the relevant web-based application may be received.

In operation S720, the service can be provided on an open platform having a plurality of web-based applications using the received web page information and a web server which shares session information of each of the plurality of web-based applications. The process of providing service on the open platform will be explained in greater detail with reference to FIG. 8.

FIG. 8 is a flowchart to of the service providing process illustrated in FIG. 7 in greater detail. In operation S810, session information may be received from at least one web-based application among a plurality of web-based applications. If the plurality of web-based applications need to open a session to provide service corresponding to the relevant web application, a request for session information is sent to a web server.

If session information corresponding to the request exists, the session information is provided to the web-based application which requested the session information in operation S820. The process of providing session information will be explained with reference to FIG. 9.

The web server and the web-based application which requested session information opens a session according to the received session information in operation S830. A session is established between the web-based application and web page according to the provided session information, and the service corresponding to the web-based application is provided to a user.

FIG. 9 is a flowchart illustrating the process of providing session information in FIG. 8 in greater detail. When a request for session information is received, whether a session name corresponding to the session information exists is determined in operation S910. If the web-based application which requested the session information is grouped with another web-based application, whether a session name corresponding to the session information exists in the group is determined.

If no session name corresponding to the session information exists, default session information is generated in operation S920, and the generated default session information is provided in operation S940. If no session name corresponding to the session information exists, a first session corresponding to the relevant group is opened. Therefore, default session information is generated so that session information used in the current web-based application can be used in other web-based applications, and the generated session information is provided to the web-based application which requested the session information.

If the session name corresponding to the session information exists, the session information corresponding to the session name is discovered in operation S930, and the corresponding session information is provided in operation S940 to be shared. If the session information already exists in the group to which the web-based application requesting the session information belongs, the session information corresponding to the session name can be provided to the web-based application which requested the session information.

According to aspects of the present invention, session information can be shared among a plurality of web-based applications by forming a session sharing unit on a framework in the form of an add-on bundle, without adjusting the web-based applications. The service providing method in FIG. 7 to FIG. 9 can be performed not only in the image forming apparatus having the structure of FIG. 1 but also in image forming apparatuses having other structures.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image forming apparatus, comprising:
a communication interface unit to communicate with an external device; and
a control unit to provide service on an open platform having a plurality of web-based applications which use web page information received via the communication interface unit and a web server which shares session information of each of the plurality of web-based applications,
wherein the session information includes user account information, password information, and/or IP address information.

2. The apparatus according to claim 1, wherein the open platform comprises:
a session sharing unit to control the web server so that session information of at least one web-based application among the plurality of web-based applications is provided to other web-based applications of the plurality of web-based applications.

3. The apparatus according to claim 2, wherein if a request for session information is received from at least one of the plurality of web-based applications, the session sharing unit controls the web server to determine whether a session name corresponding to the received request for session information exists, and controls the web server to provide the session information corresponding to the session name if the session name exists.

4. The apparatus according to claim 3, wherein the session sharing unit controls the web server to generate default session information and provide the generated default session information if no session name corresponding to the received session information exists.

5. The apparatus according to claim 2, wherein the session sharing unit divides the plurality of web-based applications into at least two groups, and controls the web server so that session information can be shared only among the web-based applications in the same group.

6. The apparatus according to claim 2, wherein the session sharing unit is formed on the open platform in the form of an add-on bundle.

7. The apparatus according to claim 1, wherein the web-based application is a copy application, a print application, a fax application, and/or a scan application.

8. An image forming apparatus, comprising:
a control unit to provide service on an open platform including a plurality of web-based applications;
wherein the open platform includes a web server to provide web page information to each of the plurality of web-based applications, and a session sharing unit to control the web server to share session information of each of the plurality of the web-based applications.

9. A service providing method of an image forming apparatus, comprising:
receiving web page information;
providing service on an open platform having a plurality of web-based applications based on the received web page information and a web server which shares session information of each of the plurality of web-based applications; and
controlling the web server via a session sharing unit of the open platform so that session information of at least one web-based application among the plurality of web-based applications is provided to other web-based applications.

10. The method according to claim 9, further comprising:
when a request for session information is received from at least one web-based application from the plurality of web-based applications, controlling the web server via the session sharing unit to determine whether a session name corresponding to the received request for session information exists, and providing the session information corresponding to the session name.

11. The method according to claim 10, further comprising:
controlling the web server via the session sharing unit to generate default session information and provide the generated default session information when no session name corresponding to the received session information exists.

12. The method according to claim 9, further comprising:
controlling the web server via the session sharing unit to divide the plurality of web-based applications into at least two groups such that session information can be shared only among web-based applications within each group.

13. The method according to claim 9, wherein the session sharing unit is formed on the open platform in the form of an add-on bundle.

14. The method according to claim 9, wherein the providing of the service comprises:
receiving a request for session information from at least one web-based application among the plurality of web-based applications;
providing the session information to the web-based application which requested the session information when session information corresponding to the received request for session information exists; and
opening a session according to the provided session information by the web server and web-based application which requested the session information.

15. The method according to claim 9, wherein the session information includes user account information, password information, and/or IP address information.

16. The method according to claim 9, wherein the web-based application is a copy application, a print application, a fax application, and/or a scan application.

17. An open platform comprising:
a plurality of web-based applications to control an image forming apparatus based on web page information; and
a session sharing unit to provide session information corresponding to at least one of the web-based applications to at least one other of the web-based applications;
wherein the session information is information employed by the plurality of web-based applications to provide a service via the image forming apparatus.

18. The open platform according to claim 17, wherein the plurality of web-based applications are installed in a web server.

19. The open platform according to claim 17, wherein the session sharing unit is installed in a web server or in the image forming apparatus.

20. The open platform according to claim 17, wherein the session sharing unit assigns each of the plurality of web-based applications to one of at least two groups, and provides session information corresponding to a web-based application only to other web-based applications assigned to the same group.
